(19) United States
(12) Patent Application Publication
(10) Pub. No.: US 2017/0001679 A1
(43) Pub. Date: Jan. 5, 2017

(54) Bicycle Grip and Bicycle Grip/Handlebar System

(71) Applicant: Canyon Bicycles GmbH, Koblenz (DE)

(72) Inventors: Wolfgang Kohl, Schwabach (DE); Lukas Schuchnigg, Koblenz (DE); Andreas Krause, Koblenz (DE); Michael Müller, Siershahn (DE)

(21) Appl. No.: 15/198,920

(22) Filed: Jun. 30, 2016

(30) Foreign Application Priority Data
Jul. 2, 2015 (DE) 20 2015 004 668.1

(51) Int. Cl. B62K 21/26; B62K 21/12

(52) U.S. Cl. CPC B62K 21/26; B62K 21/12

(57) ABSTRACT

A bicycle grip includes a sleeve which in the mounted state surrounds a bicycle handlebar. The sleeve is surrounded by a grip element or is enclosed by it by molding. A cable duct is integrated into the sleeve. Locking elements are connected to the sleeve so as to realize fixation of the bicycle grip to a handlebar end in a simple manner. A bicycle grip/handlebar system including a correspondingly designed bicycle handlebar and a bicycle grip are also provided.

### CROSS-REFERENCE TO RELATED APPLICATION

This application claims priority to German Patent Application No. 20 2015 004 668.1 filed Jul. 2, 2015, the disclosure of which is hereby incorporated in its entirety by reference.

### BACKGROUND OF THE INVENTION

Field of the Invention

The following disclosure relates to a bicycle grip and a bicycle grip handlebar system.

Description of Related Art

Particularly under the aspect of an ergonomic design of bicycle grips, bicycle grips are known which at least in partial regions include a soft grip element. To allow for safe and reliable connection of such grips with a handlebar, such bicycle grips include an interior sleeve made of harder plastic. Said sleeve is surrounded, normally by injection molding around it, by the grip element which is at least partially made of softer plastic. For fixation of the bicycle grips on the bicycle handlebar, it is known to provide clamping elements, particularly of a clip-like configuration. Said clamping elements surround the sleeves which are normally formed with a clamping slit in the clamping region. This arrangement allows for clamping fixation of the bicycle grip to the handlebar, particularly also in different positions.

Modern bicycles include an increasing number of electrically operable components. Among these, there are e.g. electric switching units, electric controllers for dampers, control units for e-bikes and the like. Such control units are often arranged on the handlebar. Optionally, an arrangement on the handlebar can make it advisable to provide a cable in the interior of the handlebar or also in the interior of the bicycle grip itself. This holds also true for the arrangement of Bowden cables for mechanical brakes, mechanical circuits and the like.

From EP 0043230, a bicycle grip is known which includes a longitudinal slit extending along the entire length. In this longitudinal slit, a tube is arranged through which a Bowen cable can be guided. A bicycle grip of a similar design is known from EP 0035855, wherein a corresponding tube for passage of a Bowden cable therethrough is arranged within the grip element made of soft plastic. Bicycle grips of this type have the disadvantage of being unsuited particularly for taking up electric cables because the grips can easily happen to rotate on the handlebar. This could cause damage to the cable.

The provision of clip-like clamping elements has the disadvantage of possible damage to Bowden cables or other cables due to the clamping forces.

Thus, it is an object of the invention to provide a bicycle grip which is suited to take up Bowden cables and particularly electric cables in a reliable manner. Another object resides in providing a corresponding bicycle grip handlebar system.

A further object resides in providing a bicycle grip which includes an anti-twist device of a simple design.

The above objects are achieved by the bicycle grip and bicycle grip/handlebar system as described herein.

### SUMMARY OF THE INVENTION

For safe arrangement of a cable, particularly an electric cable or also a Bowden cable, the bicycle grip includes a sleeve made of preferably hard material, particularly of hard plastic. In the mounted state, said sleeve surrounds the handlebar and respectively an end of the handlebar. The sleeve is surrounded by a grip element preferably made of a material which is at least partially softer. For safe arrangement of a cable, particularly an electric cable, the sleeve includes a cable duct integrated into the sleeve. By integration of the cable duct in the sleeve, the cable is arranged in an area which is safe from external influences. Thereby, squeezing or damage of the cable is avoided. Further, by the provision of the sleeve, a stable bicycle grip is realized. The bicycle grip can be fastened to the handlebar in a reliable manner, e.g. with the aid of a clamping element. With preference, however, the bicycle grip is fastened by locking elements still to be described.

The sleeve of the bicycle grip is preferably closed in circumferential direction. Thereby, the sleeve has a good stability. The cable duct integrated into the sleeve preferably extends in the longitudinal direction of the bicycle grip.

According to a particularly preferred embodiment of a bicycle grip, said sleeve is designed in such a manner that the cable duct is at least partially open toward the inside, i.e. in the mounted state in the direction of the handlebar and respectively in the direction of an end region of the handlebar. Thus, a cable can be arranged in the cable duct between an outer side of the handlebar and the sleeve. Thereby, particularly, the cable can be introduced into the cable duct in a simple manner after the bicycle grip has been mounted.

With particular preference, the cable duct is formed as a bulge of the sleeve. In this regard, the wall and particularly an outer side of the sleeve are of a continuous design. Preferably, the wall has no projections, webs and the like provided for forming the duct. This ensures a good flux of force within the sleeve. Particularly, it is possible to form the wall with a substantially uniform wall thickness, thus allowing the sleeve to be reliably produced from plastic by way of injection molding. Further, it is preferred that an outer side of the sleeve inclusive of the formed cable duct is continuous in the circumferential direction, i.e. is without interruptions.

To increase of the stiffness of the sleeve, it is possible to provide stiffening ribs on the outer side of the sleeve in the region of the cable duct. Preferably, the ribs extend in the circumferential direction of the sleeve.

An independent disclosure relates to a bicycle grip which again includes a sleeve and a grip element surrounding the sleeve and which additionally includes, on the sleeve, a locking element for fixing the bicycle grip on the bicycle handlebar, particularly in an end region of the bicycle handlebar. Such a bicycle grip with locking elements constitutes an independent disclosure, which can be combined with the above described bicycle grip with cable duct. This combination particularly has the advantage of allowing for a simple fixation of the bicycle grip on the bicycle grip handlebar with the aid of the locking elements, wherein the locking elements particularly form an anti-twist device.

Thus, a bicycle grip provided with locking elements for fixation again includes a sleeve made of preferably hard material, particularly hard plastic, which sleeve in the mounted state surrounds a handlebar and respectively an end region of the handlebar. Said sleeve is surrounded, particularly by injection molding around it, by a grip element which is at least partially made of softer material. The sleeve includes at least one locking element for fixing the bicycle grip to the bicycle grip handlebar.

Said locking element preferably includes a locking lug. The locking lug is elastically deformable and respectively bendable, thus facilitating the assembly process. Particularly, the locking element or particularly locking lug is connected, via a connecting web, to the sleeve, wherein it is particularly preferred that the locking element and the sleeve are integrally formed as one piece.

For mounting, performed particularly by shifting the bicycle grip onto the bicycle grip handlebar, it is thus possible that the locking element, particularly the locking lug, will be deflected—particularly elastically—out of a rest position. As soon as the locking element reaches a locking element provided on the handlebar, e.g. in the form of a recess, the locking element connected to the sleeve will snap into the locking element provided on the handlebar. Thus, mounting can be performed by a simple shift-on process wherein, as soon as the locking element of the sleeve has been connected to the locking element of the handlebar, there will be ensured a safe, positionally accurate fixation of the bicycle grip to the bicycle grip handlebar.

Further, it is preferred that, at a rear side of the at least one locking element, an elastically compressible element of the grip element is arranged. In this manner, a restoring force towards the rest position is generated. For example, during shift-on of the bicycle grip onto the handlebar end, the at least one locking element will first be pressed down so that said compressible element of the grip element will be compressed. As soon as the locking element is in its correct position and locks into the corresponding locking element on the handlebar, this return movement into the rest position will be enhanced by the compressible element of the grip element. Further, it is safeguarded thereby that the locking connection will not be inadvertently released.

Preferably, the at least one locking element includes an inwardly oriented projection. In the mounted state, said projection is thus oriented in the direction of the handlebar. Prior to mounting, the projection is oriented in the direction of the interior of the sleeve. The projection serves for deflecting the locking element from the rest position in the mounting process, particularly during shift-on onto the handlebar end of the bicycle grip handlebar.

A combination of a bicycle grip with locking element and additionally a cable duct is preferred. This combination has the advantage that, on the one hand, there is provided a stiff sleeve with integrated cable duct, particularly in the preferred further embodiment, and, on the other hand, the provision of at least one locking element will allow for a clearly defined position of the bicycle grip on the handlebar so that undesired twisting and resultant possible damage of the cable will be avoided.

A further embodiment relates to a bicycle grip handlebar system. Such a bicycle grip includes a sleeve surrounded by a grip element. The sleeve surrounds a handlebar end of a bicycle grip handlebar. Connected to the sleeve is a locking element which cooperates with a locking element provided in and respectively on the handlebar end. In this arrangement, the locking elements are preferably designed in the manner described above with reference to the bicycle grip. Preferably, one of the two locking elements includes a recess which, in the mounted state, has a projection of the second locking element projecting into it. Irrespective of whether the locking element including the projection is provided on the sleeve or on the handlebar, the locking element is designed in the above described manner and particularly includes a locking lug. The locking lug is connected via a connecting web to the sleeve and respectively to the handlebar.

According to a particularly preferred embodiment, the bicycle grip/handlebar system includes both a corresponding locking connection and a bicycle grip with cable duct.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic perspective view of a bicycle grip handlebar with bicycle grip,

FIG. 2 is a schematic perspective view of a bicycle grip mounted on the end region of a handlebar wherein, for better illustration, the grip element is partially cut off,

FIG. 3 is a schematic sectional view taken along line III-III in FIG. 1,

FIG. 4 is a schematic longitudinal sectional view of the end region of a bicycle handlebar with mounted sleeve, taken along line IV-IV in FIG. 2, and

FIG. 5 is a schematic longitudinal sectional view of the end region of a bicycle handlebar with mounted sleeve, taken along line V-V in FIG. 2.

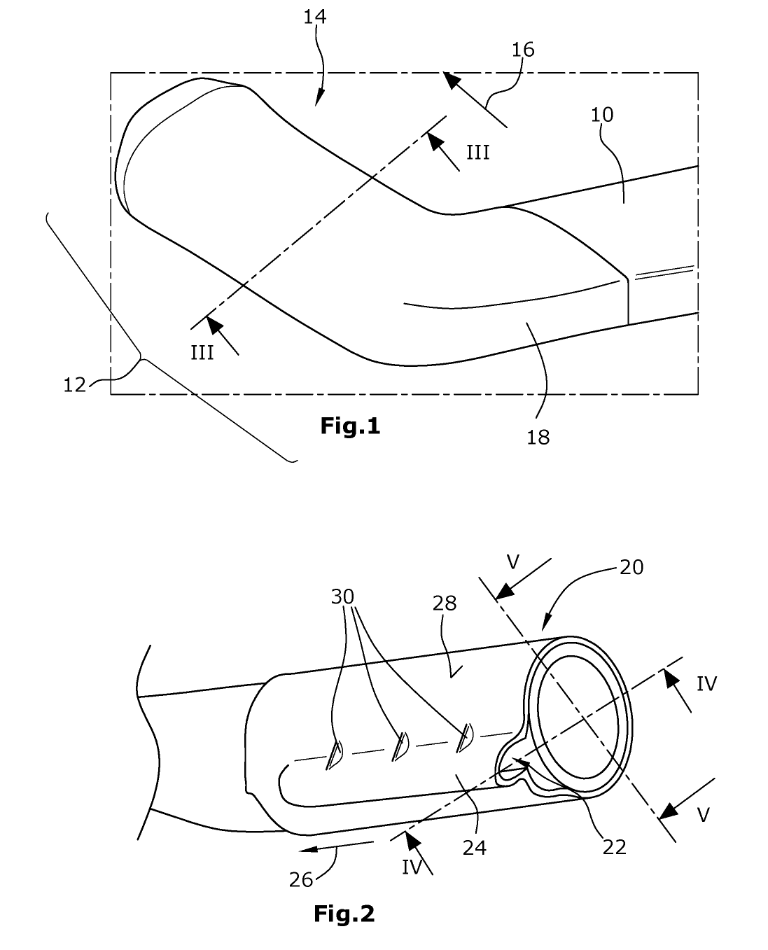

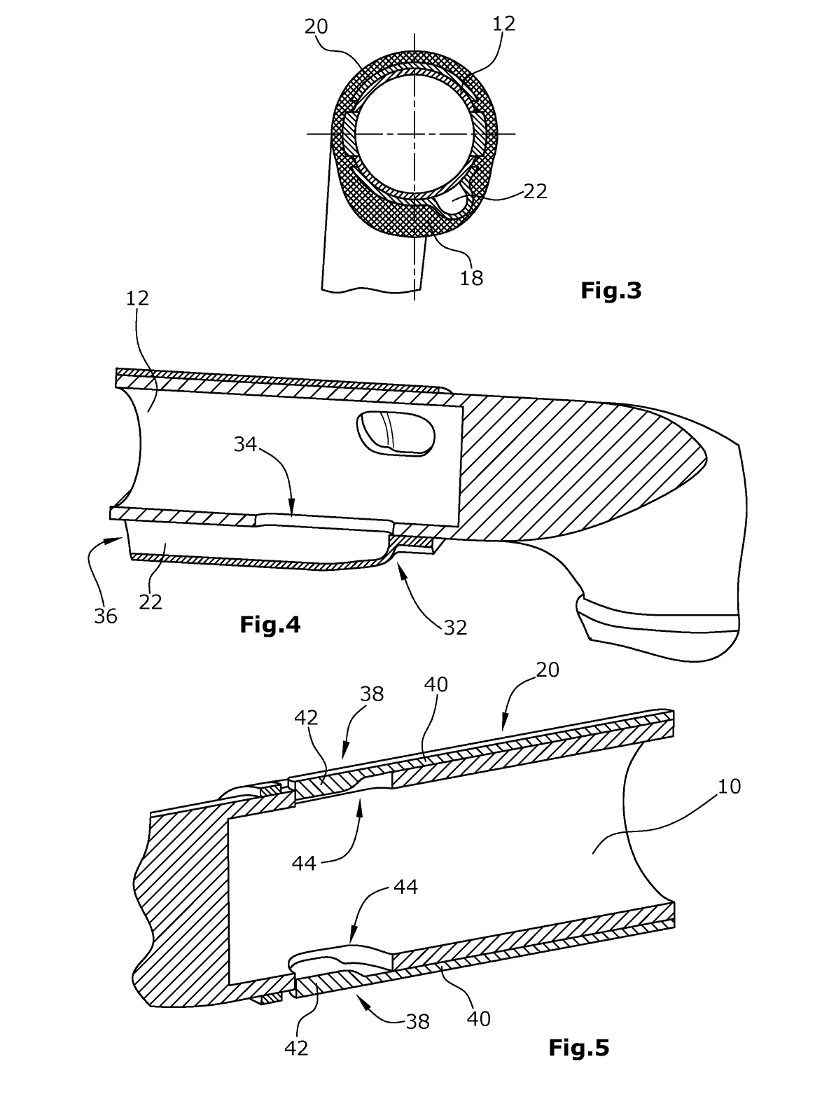

### DETAILED DESCRIPTION OF PREFERRED EMBODIMENTS

The illustrated embodiment of a bicycle grip and of a bicycle handlebar relates to a bicycle handlebar of a time trial bike or a triathlon bicycle. Similar handlebars are also provided e.g. on triathlon bicycles.

On a bicycle handlebar 10, a bicycle grip 14 is arranged in region 12. In such handlebars, the bicycle grip is oriented forward in the direction of travel 16. Bicycle grip 14 includes a grip element 18 made particularly of a soft plastic material. Said grip element 18 surrounds a sleeve 20 (FIG. 2). Particularly, the plastic forming the grip element 18 is molded around sleeve 20.

In the mounted state (FIG. 2), sleeve 20 surrounds the handlebar end 12. The sleeve 20 includes a bulge 24 for forming a cable duct 22. Said bulge 24 extends in the longitudinal direction 26 of the sleeve and respectively of the bicycle grip and is substantially U-shaped or semicircular in cross section. The cable duct 22 is thus formed between the bulge 24 and an outer side of handlebar end 12.

Said sleeve 20 is formed in one piece and has a substantially constant wall thickness both in the region of bulge 24 and in the rest of the region of the sleeve. In the illustrated preferred exemplary embodiment, cable duct 22 is thus open toward the interior, i.e.—in the mounted state—in the direction of an outer side of handlebar end 12.

An outer side 28 of the sleeve inclusive of the region of the sleeve forming the cable duct 22 is continuous and respectively closed in the circumferential direction.

In the illustrated preferred exemplary embodiment, for increased stiffening, the outer side in the region of cable duct 22 is provided with three stiffening ribs 30. Preferably, stiffening ribs are also provided on the opposite side of cable duct 22. The stiffening ribs preferably extend substantially in the circumferential direction.

For increased stiffening of sleeve 20, cable duct 22 is closed on its rear side 32 (FIG. 4). This is possible because the handlebar end 12 includes an opening 34 in the region of cable duct 22 so that a cable can be inserted into an opening 36 of the cable duct and is then guided through the opening 34 of handlebar 10 into the interior of the handlebar. The cable will then have been guided out again e.g. in the region of the stem of the fork steerer or the like.

The region 32 of cable duct 22 by which the cable duct is closed has the further purpose that, during introduction of a cable through opening 32, the cable will be deflected toward the interior and will be automatically guided through the opening 34 of the handlebar.

In the illustrated preferred exemplary embodiment, locking elements are provided for fixing the bicycle grip 14 on handlebar 10. These locking elements, illustrated particularly in FIG. 5, include two locking elements 38 formed as locking lugs. The two locking lugs are connected to sleeve 20 via connecting webs 40. Further, the two locking elements 38 include projections 42 extending into the interior of sleeve 20.

Further locking elements are provided in handlebar 10 wherein, in the illustrated exemplary embodiment, these locking elements are recesses 44. In the mounted state, the projections 42 of the locking lugs 38 project into the recesses 44 of handlebar 10. In this manner, the respective pairs of locking elements 42,44 will be locked.

During the mounting of the bicycle grip 14 onto handlebar 10, in FIG. 5 from the right-hand side, the projections 42 of the locking lugs 38 will be bent elastically outward due to the flexible connecting webs 40. As soon as the locking elements 42 are at the level of the recesses 44 of handlebar 10, they will snap into the recesses 44. This takes place already due to the elastic deformation of the connecting webs 40. This movement is additionally enhanced by the grip element 18 surrounding the sleeve 20, which grip element is made of an elastically compressible material at least in the region of the locking lugs. After mounting, the corresponding regions of the grip element 18 will be compressed by the locking lugs which have been pressed outwards. This will cause a restoring force with the effect that the locking lugs 38 will be pressed into their rest position shown in FIG. 5 and will also be held in this position. For easier survey, the grip element 18 surrounding the sleeve 20 is not illustrated in FIG. 5.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A bicycle grip, comprising:
a sleeve which in a mounted state surrounds a bicycle handlebar, and
a grip element surrounding the sleeve, wherein
the sleeve has a cable duct integrated into it.

2. The bicycle grip according to claim 1, wherein the sleeve is closed in a circumferential direction.

3. The bicycle grip according to claim 1, wherein the cable duct at least partially extends in a longitudinal direction of the bicycle grip.

4. The bicycle grip according to claim 1, wherein the cable duct is at least partially open towards an interior.

5. The bicycle grip according to claim 1, wherein the cable duct is formed by a bulge in the sleeve.

6. The bicycle grip according to claim 1, wherein an outer side of the sleeve inclusive of the cable duct is continuous.

7. The bicycle grip according to claim 1, wherein stiffening ribs are provided on an outer side of the sleeve in a region of the cable duct.

8. A bicycle grip, comprising:
a sleeve which in a mounted state surrounds a handlebar, and
a grip element surrounding the sleeve, wherein
a locking element is connected to the sleeve for fixing the bicycle grip to the bicycle handlebar.

9. The bicycle grip according to claim 8, wherein said locking element comprises a locking lug.

10. The bicycle grip according to claim 8, wherein the locking element is connected to the sleeve via a connecting web.

11. The bicycle grip according to claim 8, wherein the locking element is deflectable out of a rest position.

12. The bicycle grip according to claim 11, wherein, on a rear side of the locking element, an elastically compressible element of the grip element is arranged, said elastically compressible element generating a restoring force toward the rest position.

13. The bicycle grip according to claim 11, wherein the locking element comprises a projection oriented toward an interior, for deflecting the locking element from the rest position during mounting.

14. A bicycle grip/handlebar system, comprising:
a bicycle grip provided with a sleeve and a grip element surrounding the sleeve, and
a handlebar end of a bicycle handlebar, said handlebar end being surrounded by the sleeve of the bicycle grip, wherein
a first locking element is connected to the sleeve, said locking element cooperating with a second locking element provided in/on the handlebar end.

15. The bicycle grip/handlebar system according to claim 14, wherein one of said first and second locking elements comprises a recess and the other one of said first and second locking elements comprises a projection which in a mounted state projects into the recess.

16. The bicycle grip/handlebar system according to claim 14, wherein in a mounted state the sleeve surrounds the handlebar, and the grip element surrounds the sleeve, wherein a locking element is connected to the sleeve for fixing the bicycle grip to the bicycle handlebar, and wherein, for mounting, the locking element is deflectable, out of a rest position.

17. The bicycle grip according to claim 11, wherein the locking element is elastically deflectable.

18. The bicycle grip according to claim 11, wherein the locking element comprises a projection oriented toward an interior, for deflecting the locking element from the rest position during the shifting onto a handlebar end of the bicycle handlebar.
